(19) United States
(12) Patent Application Publication
(10) Pub. No.: US 2022/0183258 A1
(43) Pub. Date: Jun. 16, 2022

(54) SYSTEM FOR ILLUMINATING A WALKING PATH AND FOR MONITORING CANINE ACTIVITY

(71) Applicants: Amarilda VUCAJ, West Bloomfield, MI (US); Adrian BAZAJ, West Bloomfield, MI (US)

(72) Inventors: Amarilda VUCAJ, West Bloomfield, MI (US); Adrian BAZAJ, West Bloomfield, MI (US)

(21) Appl. No.: 17/124,435

(22) Filed: Dec. 16, 2020

(51) Int. Cl. A01K 27/00; A01K 29/00; H04B 1/38

(52) U.S. Cl. CPC A01K 27/006; H04B 1/38; A01K 29/005; A01K 27/009

(57) ABSTRACT

A canine-based illumination device and data monitoring system includes a source of animal data that can be transmitted electronically. The source of animal data includes at least one sensor. The animal data is collected from at least one canine specimen. The system also includes a device that receives the animal data from the source of animal data as a first set of received animal data and a home station that receives the first set of received animal data. Characteristically, the system includes a transceiver operable to receive signals from the source of animal data and to send control signals such as illumination signals to ta light associated with a dog collar or harness.

### TECHNICAL FIELD

In at least one aspect, the present invention is related to a system for illuminating a walking path and for monitoring canine activity.

### BACKGROUND

Continuing advances in the availability of information over Bluetooth technology have substantially changed the way that a dog walker or owner may illuminate a path ahead and gather information about a dog and its environs. Simultaneous with this information explosion, sensor technology, and moreover, biosensor technology has also progressed. In particular, biosensors that measure electrocardiogram signals, blood flow, body temperature, perspiration levels, or breathing rate are now available. A server to collect and organize information collected from such biosensors that are mounted on for example a dog collar do not exist. Moreover, access to and monitoring such sensors while a dog is in a designated location or engaged in certain activities are not yet available.

Accordingly, there is a need for systems and methods that collect and organize sensor data from a dog during activities such as walking that require safe and informative illumination and monitoring.

Among the art considered in preparing this patent application are the following: U.S. Pat. No. 6,805,460, 8,230,823, 10,548,298, 20120206906, 20170196201.

### SUMMARY

In at least one aspect, a system for illuminating a walking path and monitoring canine behavior and characteristics is provided. The system includes a source of canine data, such as a dog's position that is electronically transmittable. The source of canine data includes at least one sensor. The canine data are collected from at least one dog. The system also includes a first set of received canine data, and a computing system (e.g., home station and/or a third-party platform and/or intermediary server) that is operable to receive at least a portion of the first set of received canine data. Characteristically, one or more receivers mounted upon or associated with a dog walker or owner include a transceiver operable to receive one or more signals from the source of canine (e.g., the dog's position) and to send one or more control signals to for example an illumination device.

Advantageously, the methods and systems set forth herein have applications in the dog's sports/fitness modalities, its safety and its general wellness monitoring.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1, including FIG. 1A, FIG. 1B and FIG. 1C, is an environmental view that depicts a dog, its collar (or harness), one or more sensors, a transmitter, a transmitter, and a microprocessor associated with for example a smartphone associated with a dog walker with its graphical user interface.

FIG. 2, including FIG. 2A, FIG. 2B and FIG. 2C schematically illustrates a representative illumination path and signals that pass between a smartphone and a transceiver mounted on a dog harness or dog collar;

FIG. 3 is a high level view of a representative set of process steps in practicing one variant of the disclosed method and system.

FIG. 4 is a schematic of a series of substeps that enable battery life to be monitored.

FIG. 5 is a schematic of a series of substeps that sense and report light status.

FIG. 6 is a schematic of a series of substeps that sense and report canine heartbeat status.

FIG. 7 is a schematic of a series of substeps that sense and report canine step counts.

FIG. 8 is a schematic of a series of substeps that sense and report a dog's location.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural references unless the context clearly indicates otherwise. For example, a reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Throughout this application, if publications are referenced, the disclosures of these publications in their entireties are hereby incorporated by reference into this application to more fully describe the state of the art to which this invention pertains.

When a computing device is described as performing an action or method step, it is understood that the computing device is operable to perform the action or method step typically by executing one or more lines of source code. The actions or method steps can be encoded onto non-transitory memory (e.g., hard drives, optical drive, flash drives, and the like).

The term “computing device” generally refers to any device that can perform at least one function, including communicating with another computing device.

The term “server” refers to any computer, microcomputer, microprocessor, computing device, mobile phone, smartphone, desktop computer, notebook computer or laptop computer, distributed system, blade, gateway, switch, processing device, or a combination thereof adapted to perform the methods and functions set forth herein. A server may be housed on the person or clothing worn by a dog walker.

The term “subject” refers to a dog or other animal, including cats as well as all mammals such as primates (particularly higher primates), horses, sheep, dogs, pigs, rabbits, and cows.

The term “animal data” refers to any data obtainable from a (preferably) canine subject that can be transformed into a form that can be transmitted (e.g., wireless or wired transmission) to a server or other computing device, usually associated with for example a dog walker or owner at or near his/her place of residence. Animal data includes any data that can be obtained from sensors, and in particular, biological sensors. Animal data also includes any descriptive data, such as heartbeat data that can be manually entered or otherwise provided.

The term “sensor data” refers to the unprocessed or manipulated signal generated by a sensor. In some cases, sensor data may also include characteristics related to the sensor itself.

The term “insight” refers to descriptions that can be assigned to a targeted canine specimen that describe a condition or status of the targeted dog. Examples include descriptions or other characterizations of heartbeat, stress level, energy level, and the like. Insights may be quantified by one or more numbers, a plurality of numbers, a graph, a lot, a color or other visual representation, or a verbal description (e.g., high stress, low stress) that are predetermined.

The term “computed asset” refers to one or more numbers, a plurality of numbers, metrics, insights, graphs, or plots that are derived from at least a portion of the raw animal data. The sensors used herein initially provide an electronic signal. The computed asset is extracted or derived, at least in part, from the electronic signals. The computed asset describes or quantifies an interpretable property of the one or more targeted canine specimens. For example, electrocardiogram signals can be derived or extracted from analog front-end signals and heart rate can be derived or extracted from electro-cardiogram signals. Location coordinates can be calculated or extracted from GPS or RFID data.

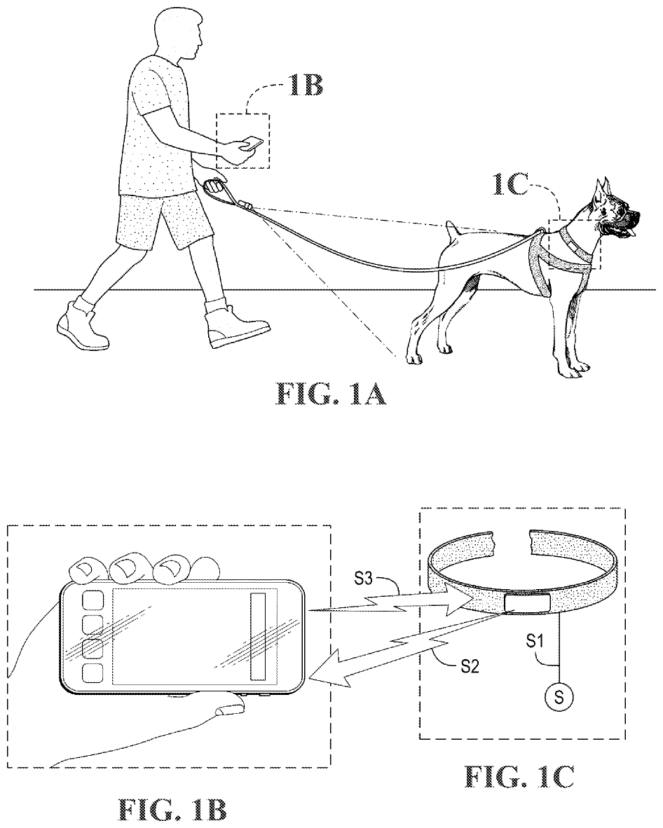

FIG. 1, including FIGS. 1A-C, is an environmental view which depicts a dog, its collar (or harness), a sensor, a receiver that receives signals from a sensor, a transmitter that sends a signal to a server that may be associated with a dog walker for example, and a smartphone with its graphical user interface (GUI). In general, a signal S1 denotes a canine or equipment characteristic detected by a sensor and communicated to a receiver mounted on a dog collar or harness (hereinafter “collar”). Alternatively, the signal could be sent directly to a home-based server where the dog resides. A representative signal S2 (e.g., indicative of heartbeat) is sent by the collar-mounted transmitter to the smartphone. After processing, a signal S3 may be sent by the smartphone to the collar-mounted microprocessor (e.g., increase the lighting intensity).

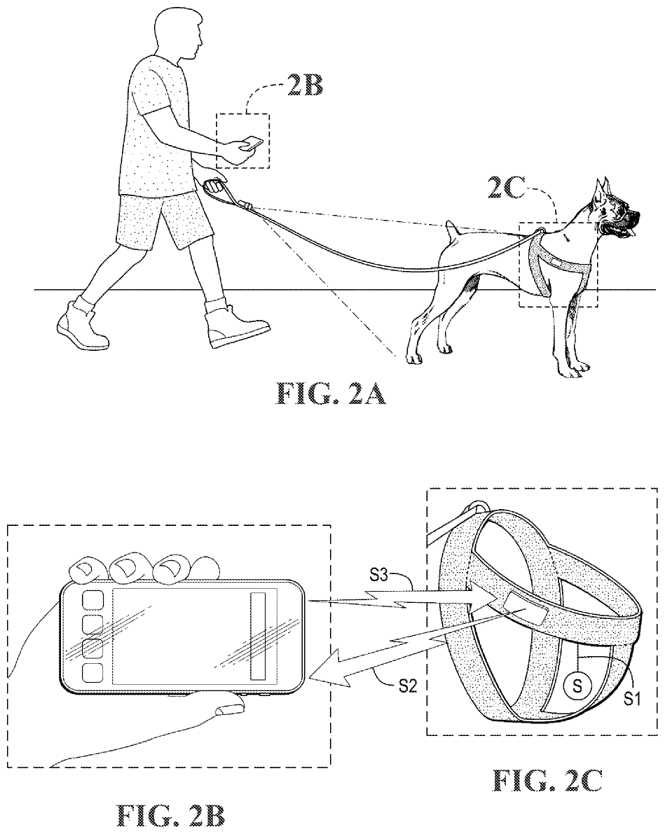

FIG. 2 illustrates an embodiment where a harness is deployed.

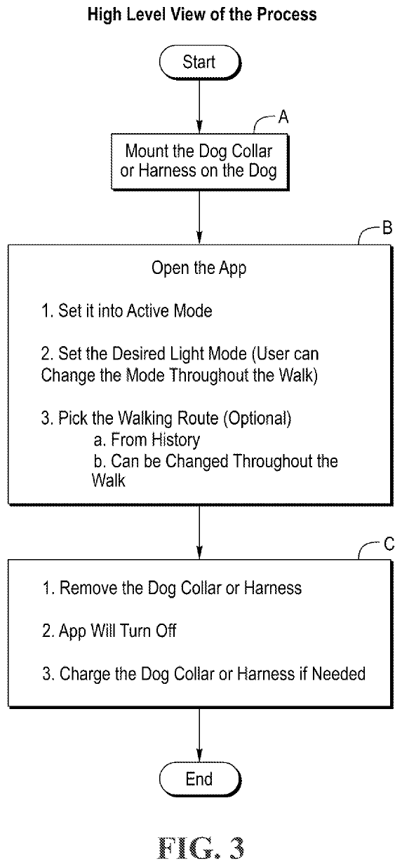

FIG. 3 (steps A-C) is a high level schematic of a system and method for collecting and displaying animal such as canine (dog) data. In step A, a user mounts for example a dog collar on a dog. The dog collar includes components to be described. In step B the dog walker opens an app that for example may be executed on a smart phone. Upon opening the app, the app is set into an active mode. Then the user is optionally invited to specify a desired light mode. This is helpful for example in a situation where the dog walker and the dog are planning to walk or walking in a dark environment. In practice, it is often helpful for the dog walker to be able to not only see the road ahead, but also to be able to perceive an object or situation that attracts the dog's sense of smell. Awareness of such situations may improve certain safety aspects of dog walking and reduce the probability of the dog becoming soiled or contracting an infectious disease. The user can change the light mode throughout for example the act of walking a dog.

If desired, the user may select a walking route, either from history, or if desired, the route can be changed at any stage in the walk. Consider a situation in which two homeowners share the responsibilities of looking after the dog. One homeowner may elect to stay at home while the other dog owner may elect to take the dog for a walk. In such situations, it may be helpful for the domiciled dog owner to monitor the progress of the dog's walk and pinpoint its location.

After the walk, the dog collar can be removed, and the app can be turned off. If desired, a power storage device associated with the dog collar can be recharged.

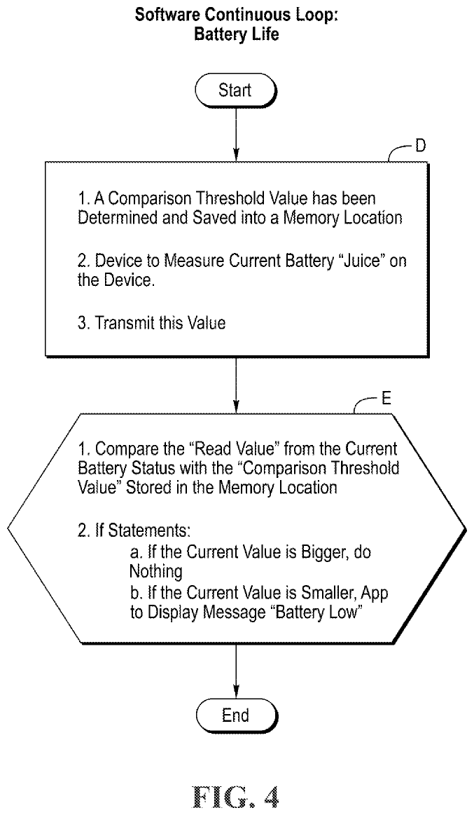

Subsequent Figures illustrate some of the optional process steps in more detail. In FIG. 4, step D determines a comparison threshold value that characterizes battery life. That value is then saved into a memory location associated with a microprocessor. The microprocessor compares the actual battery energy level with the desired energy level. The result of that comparison is then transmitted to the user through a graphical user interface (GUI) associated with the app.

A number of illustrative comparisons and actions are suggested in step E. First, a read value characterizes the current battery status and is compared with the comparison threshold value that is stored in memory. If the present value is larger than the threshold value, no further action is taken. If present value is small, the app then displays a message that indicates that the battery is low.

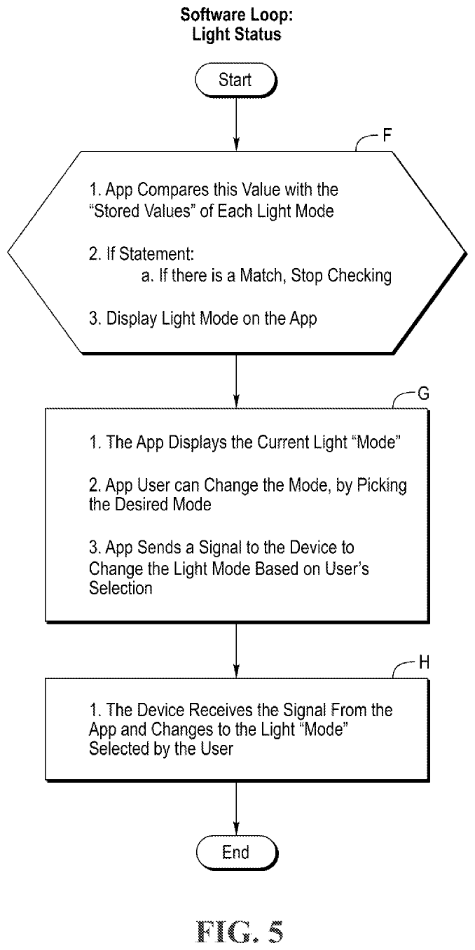

In FIG. 5 (step F), the app processes a signal that characterizes certain stored values of each light mode, e.g., on/off, color, intensity. If there is a match, no further action to change the light mode is taken. Then the light mode is displayed on a user interface associated with the app (step G). In step G, a user if desired can change the current light mode by selecting a desired mode. The app sends a signal to a lighting device which changes the light mode based on the user's selection. In step H, a collar-mounted or harness-mounted microprocessor receives the signal from the app and changes the actual light mode to the light mode selected by the user. The light itself may be mounted on the collar, on a harness or on a handle attached to the leash. Optionally, the light could be mounted on apparel associated with the dog walker, e.g., an arm, a sleeve, a shoulder or a lapel.

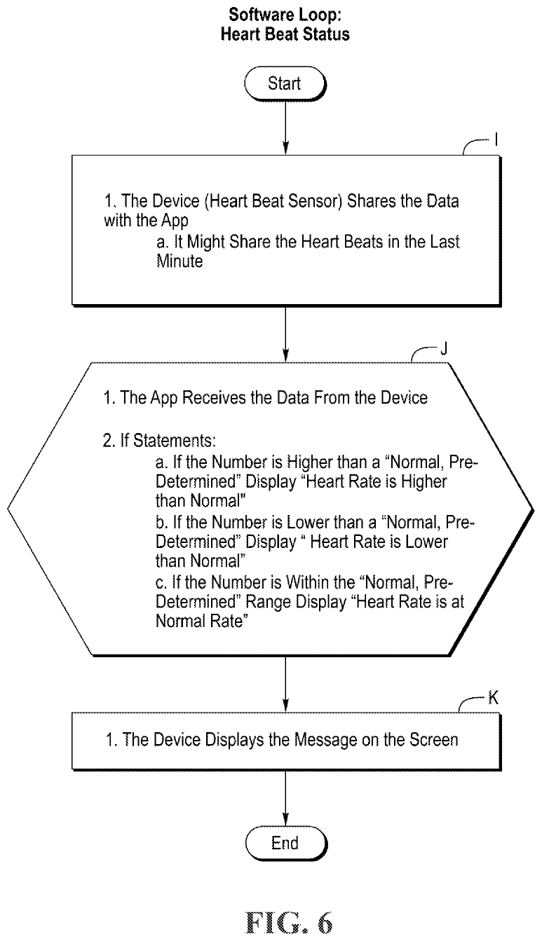

In FIG. 6, there is a series of substeps involved in monitoring for example the status of the animal's heartbeat. Step I suggests that the heartbeats are sensed and representative data are shared with the app. Optionally, the heartbeat data that is shared corresponds to the heartbeats observed in a previous time interval, such as the last minute. In substep J, the app receives the data from the sensor. If the number is higher than normal, a message is generated at the user interface interface, such as “heart rate higher than normal”. If the number is lower than a normal predetermined value, a signal is sent to the user display to communicate that the heart rate is lower than normal. If the actual heart rate is within a normal predetermined range, the user interface signifies that the heart rate is normal (Step K).

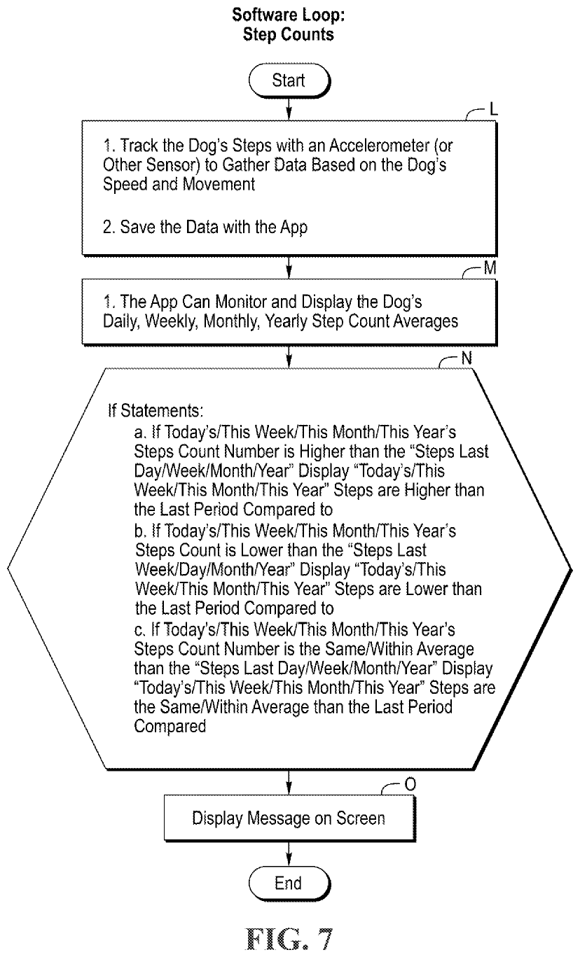

FIG. 7 is based on canine step counts. In step L, the dog's steps are tracked with for example an accelerometer or other sensor which gathers data based on the dog speed and movement. Representative data is shared with the app. In step M, the app monitors and displays the dogs daily, weekly, monthly or annual step counter averages.

Step N considers whether the step count is higher than steps made in a previous corresponding time interval. Corresponding messages are sent to the user interface to the effect for example that steps are higher than the last comparison. Correspondingly if lower, a suitable message is sent to the user interface. But if the steps are roughly comparable between the current and previously observed steps, a message to that effect is communicated to the user interface (step O).

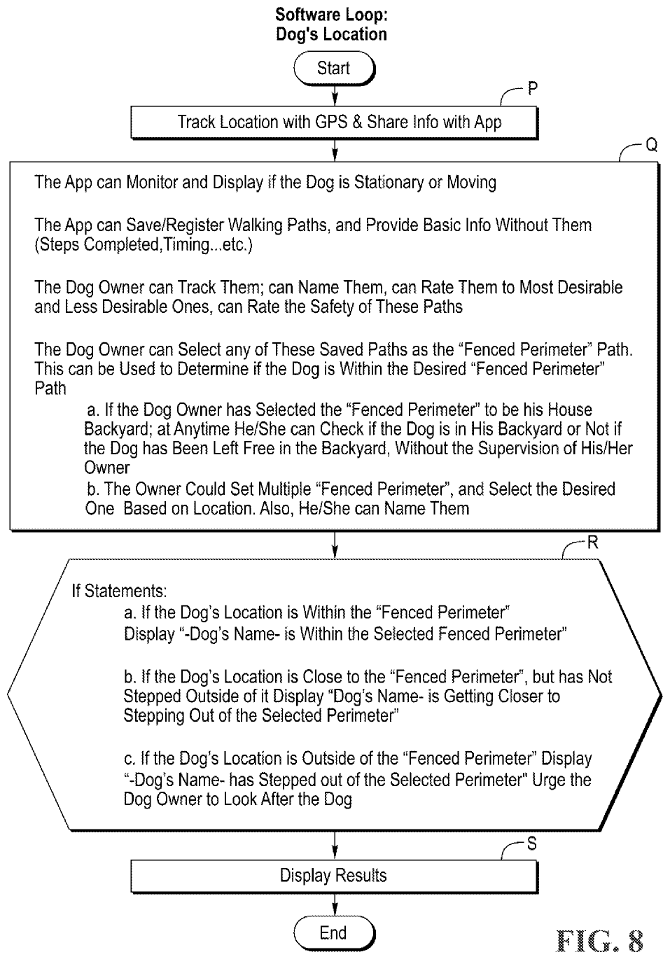

FIG. 8 focuses on the dog's location. The disclosed system includes a feature that can track the dog's location using for example a built-in GPS or other high-tech sensor program, which gathers data based on location and movement of the dog. That data is then shared with the app. In step Q, the app can monitor and display whether the dog is stationary or is moving. The app then is capable of saving and registering walking paths and providing basic information about them, such as steps completed, timing, etc. If desired, the dog owner can track them, can name them, and can rate them by suggesting what are the most desirable and less desirable tracks. Optionally, the user can rate the safety of these paths.

Continuing with step Q, in one refinement, the dog owner can select any of these saved paths, e.g. as the “fenced parameter” path. If the dog owner has selected the fenced parameter to be his house backyard, he can at any time check to see if the dog is in his backyard. If the dog is be left free in the backyard, situation monitoring can be accomplished without owner supervision. Optionally, the unit user can set multiple fence parameters and can select the desired one or ones based on location. If desired, the user can name them.

In step R, if the dog's location is within the “fenced parameter” display, a message is sent to the user interface to communicate that the dog is within the selected fenced parameter. If the dog's location is close to the fenced parameter but does not step outside, a message can be sent to the user interface which signifies that the dog is getting closer to stepping beyond the selected parameter. If the dog's location lies outside the fenced parameter, a message can be sent to signify that this event has occurred, thereby urging the dog owner to look for the dog. Optionally, results of these inquiries can be signified by the user interface. (step S).

Various facets of the disclosed system and method will now be discussed. In several embodiments, the system includes a source of animal data that can be transmitted electronically. One dog for example is the subject from which corresponding animal data is collected. In this context, animal data refers to data related to a dog's body obtained from sensors and, in particular, biosensors as set forth below in more detail. Therefore, the source of animal data includes at least one sensor that preferably is mounted on a dog collar. Characteristically, one or more receivers are mounted on a dog collar that in one instance communicate directly or indirectly with the one or more sensors.

In a variant, certain metadata includes information documenting the one or more activities in which a dog is engaged (such as walking or running) while the animal data are collected. The metadata can be attached to the collected animal data by another computing device as set forth below.

In one refinement, a sensor can directly communicate wirelessly via wireless links to a server. In this regard, a representative transmission system can utilize any number of communication protocols including, but not limited to, Bluetooth, cellular, LoRa, Ant+, WiFi, and the like.

In another refinement, a collar-mounted receiver is able to communicate with the at least one sensor from the dog using one or more communication protocols. In a variation, the receiver is able to communicate with the at least one sensor using one or more communication protocols simultaneously.

In another refinement, sensor data are processed by a collar-mounted computing device which mediates the sending of animal data to the home-based receiver, i.e., it collects the animal data and transmits it to receiver. For example, the home-based receiver can be a smartphone, smartwatch, tablet or a computer carried by or proximate to the dog. In a refinement, a single collar-mounted computing device can mediate the sending of animal data from a plurality of data sources.

It will be appreciated that the home-based receiver can be a server, laptop, mobile device, tablet or other computing device. In this variation, a user selects a sensor and opens the app. Typically, the sensor has been previously integrated with the control application prior to communicating with the receiver. In a refinement, the sensor(s) uses the control application and the receiver's recognized/established communication protocols. In a variation, the receiver communicates with sensor(s) and/or home station via a cloud.

In yet another variation, a home-based server monitors the one or more collar-mounted sensors and (1) alerts another home stations, intermediary servers, or third-parties, and/or (2) prompts the home station to take at least one corrective action in furtherance of delivering an expected output to one or more of the home station, intermediary server, or third-party. For example, the system may be capable of monitoring the receiver and take corrective actions related to error conditions and failure. If the connection between sensor and receiver is weak or the receiver has a power issue (e.g., battery degradation, FIG. 4), a suitable diagnostic message can be sent to the GUI. Similarly for light status (FIG. 5). In another example, if a receiver determines that at least one sensor is bad, an automated trigger may occur whereby a backup sensor is deployed to try and connect with the faulty sensor, or the receiver sends an alert to the central server that the sensor needs to be replaced. In yet another example, the receiver may detect a health or medical condition based upon the collected animal data, which may trigger either an alert or at least a portion of the collected animal data being sent to the one or more home stations, intermediary devices or third-parties.

In some variations, -based or home-based microprocessor is in electrical communication with a memory module and/or input/output module. The microprocessor can be operable to execute one or more data processing steps, examples of which are set forth below

As set forth above, the disclosed system includes sensors, and in particular biosensors. Biosensors collect biosignals, which in the context of the present embodiment are any signals in animals (preferably dogs) that can be continually measured and monitored, including both electrical and non-electrical signals. A biosensor can gather physiological, biometric, chemical, biomechanical, genetic, genomic, location, or other biological data from a targeted individual specimen. For example, some biosensors may measure physiological metrics such as, biosignals, bioelectrical signals, blood flow, blood analysis, core body temperature, blood pressure, biological fluid, pulse, oxygenation, skin temperature, perspiration levels, glucose levels, hydration levels, lactate levels, sodium levels, potassium levels, heart rate, genetic information, muscle activity, or breathing rate.

In addition to biological data about the targeted individual, some biosensors may measure environmental conditions such as ambient temperature and humidity, elevation, barometric pressure, other audio, and other location. Specific examples of biosensors include, but are not limited to, Mc10 BioStamp nPoint (ECG+sEMG+XYZ coordinates), ECG: Vivalnk Vital Scout (ECG); Humon Hex(muscle oxygen); Apple Watch (heart rate); Polar H10 chest strap (heart rate and HRV); 23 and me (DNA/genetic testing); nebula genomics (genomic testing); NEC NeoFace Watch (facial recognition); Auditory: Sonitus technologies MolarMic (auditory); SennoFit Insole (gait analysis); Omron HeartGuide Wearable Blood Pressure Monitor, model: BP-8000M (blood pressure); Glucose: Abbott freestyle Libre (glucose); Health Care Originals ADAMM (respiration); Epicore Biosystems (hydration/sweat analysis); Kenzen Echo Smart Patch (hydration/sweat analysis); IsoLynx Athlete

Tracking Tags and Wireless Smart Nodes (RFID-based location tracking); Catapult OptimEye S5 (location tracking (GPS)); SMRT Mouth (biometric mouth guard); StrikeTec (biomechanical movement sensors for fight sports); Scanalytics (smart floor sensors); and Lockheed Martin FORTIS industrial exoskeleton products (biomechanical movements).

In a refinement, the at least one sensor is affixed to, or is in contact with, a dog's body, eyeball or skeletal system (e.g., saliva sensor affixed to a tooth, set of teeth, or an apparatus that is in contact with one or more teeth), embedded in a subject, lodged in a subject, ingested by a subject, or integrated as part of, affixed to, or embedded within, a dog collar, fabric, textile, cloth, material, fixture, object, or apparatus that contacts or is in communication with a target subject either directly or via one or more intermediaries.

User interfaces (GUI's) are provided. A user logs into the control application via user interface, typically by entering a “username” and “password” and then actuating a control element. The interface is then presented to the user. In one variant, list box shows a list of target animals that can be selected for monitoring. The user can select one or more individuals to monitor. A control element finalizes the selection. The user then chooses at least one sensor from a sensor list associated with the selected dog. It should be appreciated that a sensor may capture more than one metric. For example, a sensor that captures ECG may also have an accelerometer, gyroscope, and magnetometer in it to capture X,Y,Z coordinates. A control element finalizes the selection.

After selecting the target individuals and sensors, a user interface is displayed. The user identifies which of the selected sensors are to be operated. This is accomplished by highlighting the selected one or more target individuals in a list box. The sensor in the list box powers the sensor(s) “on” via a control element if required.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A canine illumination and data monitoring system comprising:
a dog collar or harness with one or more sensors associated therewith;
an illumination device associated with the dog collar, harness or a handle extending from a dog leash, the illumination device being adapted to be activated in response to a signal emitted by one or more of the one or more sensors;
a receiver that receives the signal from one or more of the one or more sensors, the receiver having a transceiver operable to receive the one or more signals and to send one or more signals to a server that is associated with a dog walker or is home-based; and
a computing device in communication with the server that is operable to process at least one of the one or more signals and send a signal via the transceiver to the illumination device.

2. The system of claim 1 wherein a sensor is directly affixed to the dog.

3. The system of claim 1 wherein a home station is programmed to automatically select one or more receivers to connect with the at least one sensor based on one or more of following characteristics: specimen location, sensor location, battery life, light status, signal strength, environmental conditions, or signal quality.

4. The system of claim 1 wherein the at least one sensor is affixed to, or is in contact with, or is in electronic communication with a subject's body, embedded in an individual, lodged in an individual, ingested by an individual, or integrated as part of, affixed to, or embedded within, a dog collar, a harness, a fabric, textile, cloth, material, fixture, object, or apparatus that contacts or is communication with a dog.

5. The system of claim 1 wherein a sensor is a biosensor that gathers physiological, biometric, chemical, biomechanical, location, environmental, genetic, genomic, or other biological data from one or more targeted individual specimens.

6. The system of claim 5 wherein the sensor gathers at least one of biosignals, bioelectrical signals, blood flow, blood pressure, skin temperature, location data, location coordinates, ambient temperature and humidity, barometric pressure, elevation, or a combination thereof.

7. The system of claim 1 wherein the computing device executes a control application that executes one or more commands.

8. The system of claim 1 wherein the receiver includes a data acquisition unit that communicates with the at least one sensor.

9. The system of claim 8 wherein the data acquisition unit includes a transceiver module that communicates with the sensor via a two-way communication link in which a user can activate and set one or more parameters for the at least one sensor and receive one or more data signals from the at least one sensor.

10. The system of claim 9 wherein the transceiver module is operable to communicate with a home station, third-party, and/or an intermediary server.

11. The system of claim 10 wherein the data acquisition unit includes a microprocessor operable to execute one or more data processing steps.

12. The system of claim 11 wherein the data acquisition unit includes a memory module and an input/output module in electrical communication with the microprocessor.

13. A method for activating a dog-mounted illumination device comprising the steps of:
mounting a dog collar or harness on a dog;
opening an app associated with a smartphone; and
specifying a light mode so that a dog walker may see the road ahead of the dog and be able to perceive an object or situation that attracts the dog's sense of smell, thereby improving certain safety aspects of dog walking and reducing the probability of the dog becoming soiled or contracting an infectious disease.
